(19) United States
(12) Patent Application Publication
(10) Pub. No.: US 2013/0141454 A1
(43) Pub. Date: Jun. 6, 2013

(54) DEVICE AND METHOD FOR DISPLAYING IMAGES

(71) Applicant: SAMSUNG ELECTRONICS CO., LTD., Suwon-si (KR)

(72) Inventors: Jason PARK, Anyang-si (KR); Sang-un YUN, Seoul (KR); Min-cheol HWANG, Seoul (KR); Jun-ho SUNG, Seoul (KR)

(73) Assignee: SAMSUNG ELECTRONICS CO., LTD., Suwon-si (KR)

(21) Appl. No.: 13/677,352

(22) Filed: Nov. 15, 2012

(30) Foreign Application Priority Data
Dec. 2, 2011 (KR) 10-2011-0128672

(51) Int. Cl. G09G 5/02

(52) U.S. Cl. CPC G09G 5/02
USPC 345/589

(57) ABSTRACT

A device for displaying images is provided, in which the device includes an image analyzing unit which analyzes an incoming unit frame image and provides a result of the analysis related to an area on which a color characteristic is expressed, which has a different characteristic from a color characteristic of a peripheral area, and a backlight which includes light emitting diodes (LED), each LED operates differently according to presence and absence of the area on which the color characteristic is expressed, which has a different characteristic from the color characteristic of a peripheral area is expressed, by using the result of analysis.

### CROSS-REFERENCE TO RELATED APPLICATIONS

This application claims priority from Korean Patent Application No. 10-2011-128672, filed on Dec. 2, 2011, in the Korean Intellectual Property Office, the disclosure of which is incorporated herein by reference in its entirety.

### BACKGROUND

1. Field

Devices and methods consistent with the embodiments relate to displaying images. More particularly, embodiments relate to a device and a method for displaying images which enhances color breakup by adaptively controlling backlight, through image analysis, in a color filterless liquid crystal display (LCD) for outdoor use.

2. Description of the Related Art

A liquid crystal display (LCD) displays images, when an electric field is applied to a crystal layer with bidirectional dielectric permittivity injected between two substrates, by adjusting an amount of light transmitted through the substrates to adjust the magnitude of the electric field. Thus, a desired image signal is acquired.

An LCD of the related art generally has the color filter layers consisting of three primary colors, i.e., red (R), green (G) and blue (B), on one of the two substrates, and displays the desired color by regulating the amount of light passing through the color filter layers. In other words, the LCD displays the color by adjusting an amount of white light passing through the R, G and B color filter layers and synthesizing the R, G and B colors.

The LCD of the related art displays color using white light and three color filter layers. Thus, the LCD of the related art needs pixels corresponding respectively to R, G and B regions. In other words, the LCD of the related art needs triple times more pixels than the pixels required for a black and white display. Accordingly, very sophisticated LCD panel manufacturing technology is required to obtain high resolution images. Further, there is inconvenience in the manufacturing process due to a need for a separate color filter layer for the substrate. Also,it is difficult to enhance the light transmittance of the color filter in the LCD of the related art.

In light of the above, a field sequential color (FSC) type of LCD, i.e., CFL, was suggested, which uses three color light sources to sequentially turn on RGB independent light sources periodically, and adds a color signal corresponding to each pixel in synchronization with the light-on period to obtain a full color image. The CFL has the LCD and RGB LED in synchronization with each other, in which the LCD and LED are driven sequentially so that the colors are accumulated to express a final color image. The most important factor to determine the color expression of the CFL can be the fast operation of the LCD and color separation by the accurate synchronization between the backlight and the LCD operation.

However, in addition to the variation in color gamut or flicker due to color mixing based on the sequential driving of the RGB backlight, the CFL suffers from more color breakup than a general LCD.

### SUMMARY

According to one or more exemplary embodiments, a device and a method is provided for displaying images, which are capable of improving color breakup by analyzing an incoming image and adaptively controlling a backlight in accordance with the result of analysis.

According to an aspect of an exemplary embodiment, a device for displaying images is provided, which may include an image analyzing unit which analyzes an incoming unit frame image and provides a result of analysis related to an area on which a color characteristic is expressed, which has a different characteristic from a color characteristic of a peripheral area, and a backlight which comprises light emitting diodes (LED), each LED operates differently according to presence and absence of the area on which the color characteristic is expressed, which has a different characteristic from the color characteristic of peripheral area, by using the result of analysis.

The backlight may drive the LED of the area in a sequential manner, if the incoming unit frame image does not include the area on which the color characteristic is expressed, which has a different characteristic from the color characteristic of the peripheral area, and drive the LED of the area on which the color characteristic is expressed, which has a different characteristic from the color characteristic of the peripheral area, in a manner other than the sequential driving manner, if the unit frame image includes the area on which the color characteristic is expressed, which has a different characteristic from the color characteristic of the peripheral area.

The image analyzing unit may provide, as the result of analysis, location information of the area on which the color characteristic is expressed, which has a different characteristic from the color characteristic of the peripheral area.

The peripheral area may have more color components or higher color purity than the area on which a color of different characteristic from that of peripheral area is expressed, and the area on which the color characteristic is expressed, which has a different characteristic from the color characteristic of the peripheral area, may express a gray component, a monochromatic component, and a complex color component of two colors.

The image analyzing unit may analyze R, G, B pixel values of the incoming unit image frame and determines the image to be the gray component, if the R, G, B pixel values have a same grayscale.

The image analyzing unit may separate a unit frame image of mixed R, G, B to generate a R unit frame, a G unit frame, and a B unit frame and outputs the generated R frame, the generated G unit frame, and the generated B unit frame.

The image analyzing unit may additionally generate and output a black (K) unit frame or a white (W) unit frame.

The device may additionally include a lamp driving unit, and the lamp driving unit adaptively drives the backlight according to the result of analysis.

The lamp driving unit may be synchronized with part of the unit frames of the R unit frame, the G unit frame, the B unit frame, the black (K) unit frame, or the white (W) unit frame to drive the LED backlight in a RGB mode of three color driving, a WRGB mode of four color driving, or a KRGB mode of four color driving.

The lamp driving unit may control the LEDs of the backlight corresponding to the area on which the color characteristic is expressed, which has a different characteristic from that of the color characteristic of the peripheral area, are driven, and control the LEDs so that the LEDs turn into a different state in a duty region where the incoming unit frame is displayed.

The lamp driving unit may control so that if ½ region of the duty is in a black (K) state, the rest ½ region is in a white (W) state, or if the ½ region of the duty is in the white (W) state, the rest ½ region is in the black (K) state.

The white (W) state may be generated by turning on the R, G, B LEDs corresponding to the area on which the color characteristic is expressed, which has a different characteristic from the color characteristic of the peripheral area.

According to another aspect of an exemplary embodiment, a device for displaying images is provided, which may include an image analyzing unit which analyzes an incoming unit frame image and determines visibility of the incoming unit frame image, and a lamp driving unit which controls a light emitting diode (LED) backlight to turn on or off according to a result of visibility determination.

The image analyzing unit may analyze to determine if the image needs brightness compensation, has severe color breakup, or needs color rendering ability, to determine the visibility of the image.

The image analyzing unit may set at least one mode of a RGB mode, a GRWB mode, and a GRKB mode according to the result of visibility determination, and wherein W refers to white and K refers to black.

According to another aspect of an exemplary embodiment, a method for displaying images is provided, which may include analyzing an incoming image, determining at least one of: presence of an area on which a color characteristic is expressed, which has a different characteristic from a color characteristic of a peripheral area, visibility state of the image, and driving a light emitting diode (LED) backlight differently according to a result of the determination.

The analyzing the image may include comparing pixel values of a unit frame image having R, G, B mixed.

The determining of the visibility state may include determining if the image needs brightness compensation, has severe color breakup, or needs color rendering ability, to determine the visibility state of the image.

The peripheral area may have more color components or higher color purity than the area on which the color characteristic is expressed, which has a different characteristic from the color characteristic of the peripheral area, and the area on which the color characteristic is expressed, which has a different characteristic from the color characteristic of the peripheral area may express a gray component, a monochromatic component, and a complex color component of two colors.

The LED backlight may operate in a RGB mode of three color driving, a WRGB mode of four color driving, or a KRGB mode of four color driving.

The LED backlight may drive the peripheral area differently from the area on which the color characteristic is expressed.

The LED backlight may differently operate a duty region of the unit frame image, if the unit frame image is displayed by including the area on which the color characteristic is expressed, which has a different characteristic from the color characteristic of the peripheral area.

The LED backlight may drive partial region of a duty region in a black (K) state or a white (W) state.

According to a further aspect of an exemplary embodiment, a method for displaying images is provided, which may include analyzing an incoming image, determining a need for adaptive conversion based on a result of the analysis of the incoming image, and performing adaptive conversion based on the determination of the need for adaptive conversion.

The analyzing the incoming image may include distinguishing a color information expressing portion, which expresses many colors, from a grayscale information portion, which expresses text.

The analyzing the incoming image may further include generating a R unit frame, a G unit frame, and a B unit frame.

The analyzing the incoming image may further include generating a black (K) unit frame or a white (W) unit frame.

The determining the need for adaptive conversion includes determining whether the unit frame includes the grayscale information expression portion, and determining driving in either a RGB or a WRGB sequence.

When the unit frame includes the grayscale information expressing portion, the determining the need for adaptive conversion may further include determining a specific duty of an entire duty realized on a specific unit frame that is to be turned into a white (W) state or a black (K) state.

When the unit frame includes the grayscale information expressing portion, the adaptive conversion may be performed by driving the RGB LEDs corresponding to the grayscale information expression portion so that a specific duty of timing realized on a specific frame is turned into a black (K) state or a white (W) state.

When the unit frame does not include the grayscale information expressing portion, the adaptive conversion may not be performed, and the RGB LEDs are driven sequentially in a color order.

### BRIEF DESCRIPTION OF THE DRAWINGS

The above and/or other aspects will be more apparent by describing certain exemplary embodiments with reference to the accompanying drawings, in which:

FIG. 1 is a view illustrating comparison of image by a related art LCD and image by FS-LCD;

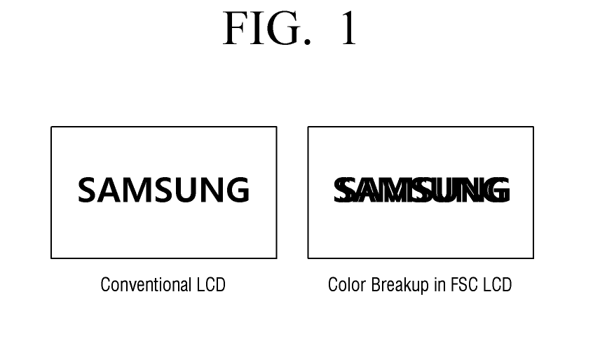

FIG. 2 is a block diagram illustrating a structure of a device for displaying images according to an embodiment;

FIG. 3 is a view provided to explain a process of analyzing images at an image analyzing unit of FIG. 2;

FIG. 4 is a view provided to explain an adaptive control operation of the image analyzing unit of FIG. 2;

FIG. 5 is a view provided to explain a method for adaptively controlling the image at the backlight of FIG. 2;

FIG. 6 is a view provided to explain controlling of the backlight in accordance with the result of analysis of the image analyzing unit of FIG. 2;

FIG. 7 is a view illustrating an example of LED arrangement of the backlight of FIG. 2;

FIG. 8 is a view illustrating an example of ADC driving in RGB mode;

FIG. 9 is a view illustrating another example of ADC driving in RGB mode;

FIG. 10 is a view illustrating a monochromatic driving in WRGB mode;

FIG. 11 is a view illustrating an ADC driving method when grayscale is realized in WRGB mode; and

FIG. 12 is a view illustrating an ADC driving method when color of weak hue is realized in WRGB mode.

FIG. 13 is a view illustrating a method for displaying images according to an embodiment.

### DETAILED DESCRIPTION OF EXEMPLARY EMBODIMENTS

Certain exemplary embodiments of the present inventive concept will now be described in greater detail with reference to the accompanying drawings.

In the following description, same drawing reference numerals are used for the same elements even in different drawings. The matters defined in the description, such as detailed construction and elements, are provided to assist in a comprehensive understanding of the present inventive concept. Accordingly, it is apparent that the exemplary embodiments can be carried out without those specifically defined matters. Also, well-known functions or constructions are not described in detail since they would obscure the embodiments with unnecessary detail.

Before explaining in further detail, it is understood that an embodiment explained herein is based on an example where the device for displaying images operate in RGB mode or WRGB (or KRGB) mode, in which unit frame images are realized in GRB order in RGB mode with the backlight being sequentially driven in synchronization with the same, while the unit frame images are realized in GRWB (or GRKB) order in WRGB (or KRGB) mode, with the backlight being driven sequentially, in consideration of the result of experiments that indicate better improvement of color breakup and flicker by the manner explained above. However, this is only written for illustrative purpose and should not be construed as limiting.

The device for displaying images in one embodiment may preferably be a digital information display (DID) for outdoor use, generally installed at places including terminals, airports, etc. In most cases, people see the DIDs in an outdoor setting where they are usually in motion, which is different from still behavior that they have when they watch TVs at home. To ensure that customers pay attention to the content thereof, which is generally an advertisement, the DID generally has many screen changes,images with high color purity, and at the same time, often displays images exclusively containing specific color, or images exclusively containing grayscale image.

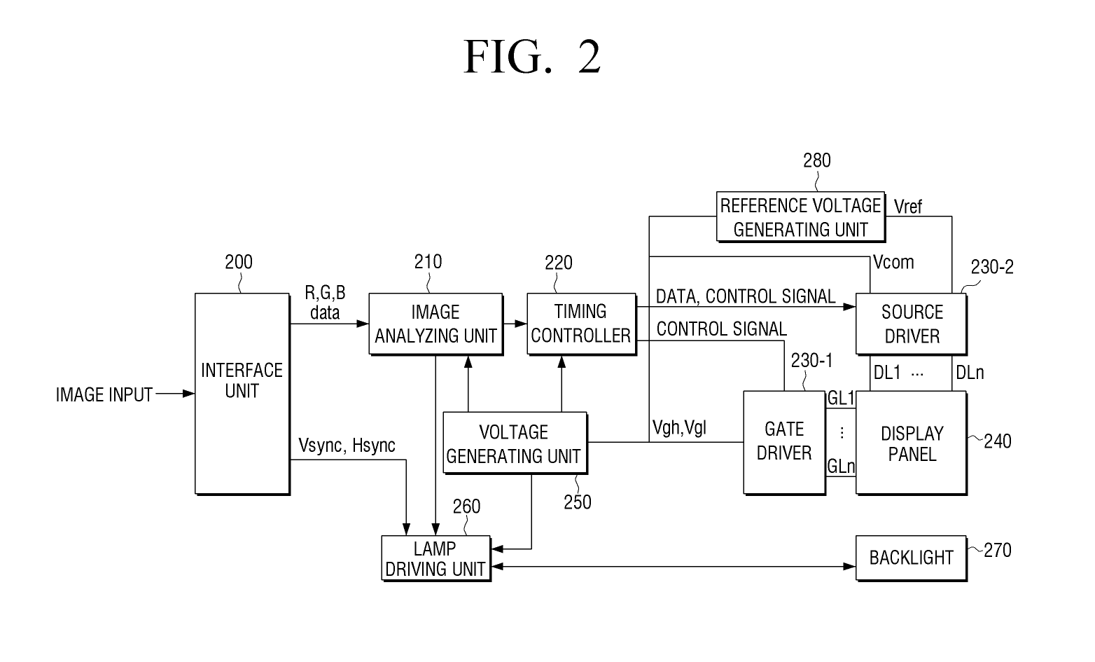

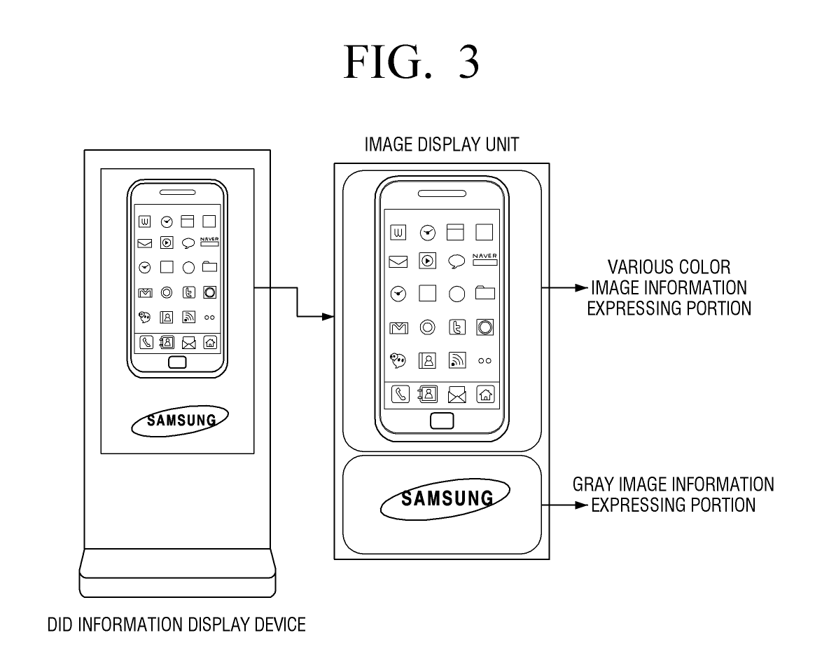

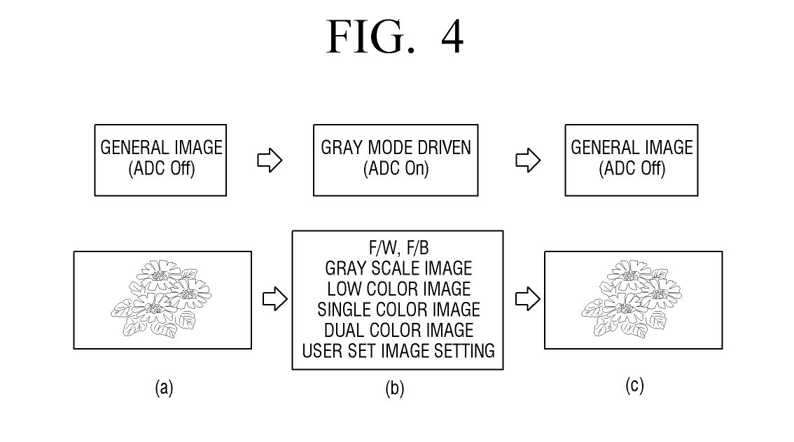

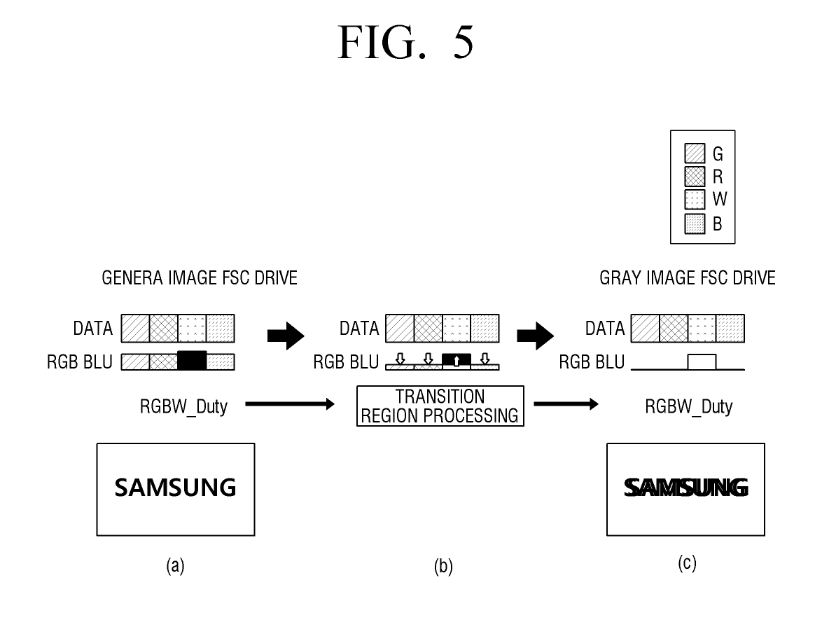

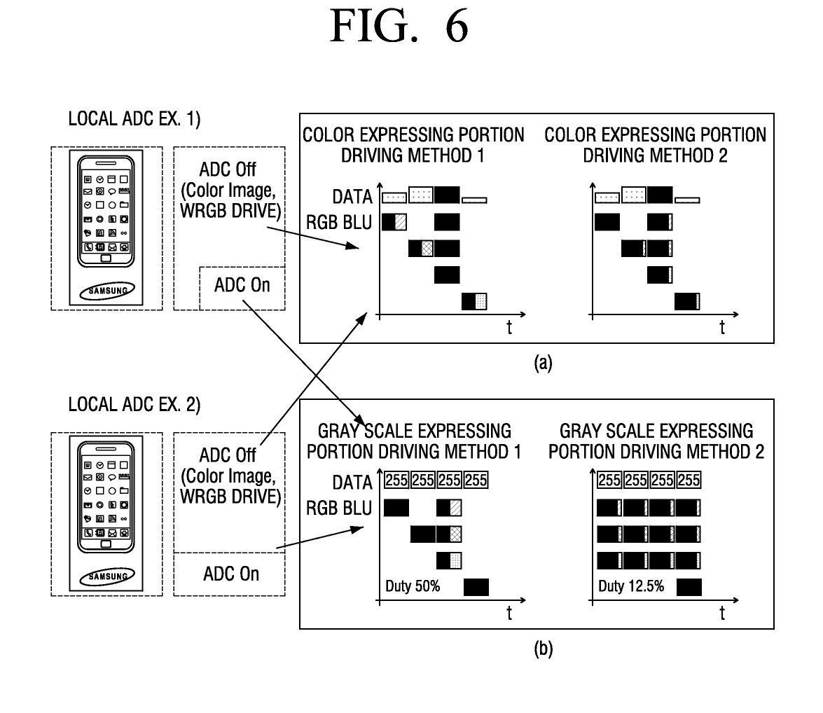

FIG. 2 is a block diagram illustrating a structure of a device for displaying images according to an embodiment. FIG. 3 is a view provided to explain a process of analyzing images at an image analyzing unit of FIG. 2. FIG. 4 is a view provided to explain an adaptive control operation of the image analyzing unit of FIG. 2. FIG. 5 is a view provided to explain a method for adaptively controlling the image at the backlight of FIG. 2. FIG. 6 is a view provided to explain controlling of the backlight in accordance with the result of analysis of the image analyzing unit of FIG. 2.

Referring to FIG. 2, a device for displaying images according to an embodiment may include part or all of an interface unit 200, an image analyzing unit 210, a timing controller 220, a gate/source driver 230_1, 230_2, a display panel 240, a voltage generating unit 250, a lamp driving unit 260, a backlight 270, and a reference voltage generating unit 280. The interface unit 200 and the image analyzing unit 210 may be provided as separate devices.

The interface unit 200 may be an image board, i.e., a graphics card for example, which changes the image data inputted from outside to a resolution to suit the device for displaying images and outputs the changed image data. The image data may include 8-bit RGB video data, wherein the interface unit 200 may generate control signals including a clock signal (DCLK) and vertical and horizontal synchronization signals (Vsync, Hsync) appropriate for the resolution of the device for displaying images. The interface unit 200 may provide the image data to the image analyzing unit 210, and provide the signals including Vsync, Hsync to the lamp driving unit 260 so that the backlight 270 operates in sync when the RGB unit frame images are realized on the display panel 240.

The image analyzing unit 210 may receive the image data from the interface unit 200, generate RGB unit frame images and provide the same to the timing controller 220, analyze corresponding image data, and cause the backlight 270 to be driven adaptively by controlling the lamp driving unit 260 based on the result of analysis. For example, if a unit frame image as a composite RGB image is provided from the interface unit 200, the image analyzing unit 210 in one embodiment may generate three unit frames including R unit frame, G unit frame, and B unit frame based on the RGB-mixed unit frame and provide the generated frames to the timing controller 220 for the driving of CFL.

Further, the image analyzing unit 210 may analyze the RGB-mixed unit frame or the RGB unit frames which are separately generated from each other to detect a location of a grayscale information expressing portion which expresses grayscale information. The grayscale information expressing portion as used herein may be a text region expressed in white, and black. For example, if images are displayed as illustrated in FIG. 3, the image analyzing unit 210 may detect a portion (as in upper side) on which a color image is expressed and a portion (as in lower side) on which the grayscale information is expressed, by analyzing pixel values. It may be detected as to whether the color image expresses various colors or relatively small amount of colors. Depending on the result of analysis, the image analyzing unit 210 may detect the location (such as coordinates) of the portion on which the grayscale information is expressed, and control the driving of the LEDs corresponding to the detected coordinates.

To be specific, if the image analyzing unit 210 determines, as a result of analyzing, that the incoming image is a general image which does not include grayscale information expressing portion as illustrated in (a) and (c) of FIG. 4, the image analyzing unit 210 provides related information to the lamp driving unit 260 so that the backlight 270 is driven in GRB or GRW(K)B sequence, for example. The LEDs of the entire region of the backlight 270 may be driven in sequence. The letter ‘W’ as used herein indicates that the backlight 270 is turned on to form a white light, while the letter ‘K’ as used herein indicates that the backlight 270 is turned off to a black state. On the contrary, if the image analyzing unit 210 determines that the incoming image includes the grayscale information expressing portion as a result of analysis, the image analyzing unit 210 operates in gray mode on which the image analyzing unit 210 detects a location of the grayscale information expressing portion and provides the result of detection to the lamp driving unit 260 so that the corresponding LEDs are driven. The color information expressing portion other than the grayscale information expressing portion may be driven in a normal sequence, i.e., GRB or GRW(K)B sequence. As explained above, the image analyzing unit 210 causes the backlight 270 to adaptively operate in accordance with the result of analyzing the incoming images.

The timing controller 220 provides video data consisting of RGB unit frames received from the image analyzing unit 210 to a source driver 230_2, and controls the video data output from the source driver 230_2 using a control signal, so that RGB unit frames are realized on the display panel 240 in sequence. Further, the timing controller 220 may control the gate driver 230_1 so that the gate on/off voltage provided from the voltage generating unit 250 is provided to the display panel 240 per horizontal line. For example, if the gate voltage is applied to gate line 1 (GL1), the timing controller 220 controls the source driver 230_2 to apply the video data corresponding to the first horizontal line. The timing controller 220 then causes the gate line 2 (GL2) to turn on, while causing the first gate line to turn off at the same time, so that the video data corresponding to the second horizontal line is applied from the source driver 230_2 to the display panel 240. In this manner, the R, G or B unit frame image is displayed on the entire screen of the display panel 240.

The gate driver 230_1 receives gate on/off voltage (Vgh/Vgl) provided from the voltage generating unit 250, and applies a corresponding voltage to the display panel 240 in accordance with the control of the timing controller 220. The gate on voltage Vgh may be provided from the gate line 1 (GL1) to gate line N (GLn) in sequence when the unit frame is realized on the display panel 240.

The source driver 230_2 converts the video data provided serially from the timing controller to parallel data, converts digital data into analogue voltage, and provides the video data corresponding to one horizontal line to the display panel 240 at the same time, in sequence. Further, the source driver 230_2 may receive a common voltage (Vcom) generated at the voltage generating unit 250, and a reference voltage (Vref) provided from the reference voltage generating unit 280. The common voltage (Vcom) is provided to a common electrode of the display panel 240, and the reference voltage (Vref) is provided to a D/A converter inside the source driver 230_2 to be used when the grayscale of the color image is expressed. In other words, the video data provided from the timing controller may be provided to the D/A converter where the digital information of the provided video data may be converted into analogue voltage to express the grayscale of the color and provided to the display panel 240.

The display panel 240 may include a first substrate and a second substrate, and a liquid crystal layer interposed therebetween. The first substrate may include a plurality of gate lines GL1 to GLn and data lines DL1 to DLn crossing each other to define pixel areas, and pixel electrodes formed at the pixel areas formed by the crossing lines GL1 to GLn and DL1 to DLn. A thin film transistor (TFT) is formed on a predetermined area of the pixel area, i.e., on a corner of the pixel area. The liquid crystal is twisted to allow the RGB lights of the backlight 270 to pass in sequence, in accordance with a difference between the voltages applied to the pixel electrodes on the first substrate and the voltages applied to the common electrodes on the second substrate, during turn on of the TFT. In order to allow the RGB lights to pass in sequence, the display panel 240 in one embodiment may preferably be a CFL which does not include the color filter. In other words, in order to form unit frames with various colors, the CFL realizes an image by forming three unit frames expressed by R, G, B lights with respect to the unit frame of an incoming image. Further, in one embodiment, the CFL may have CSD in which R, G, B sub pixels are integrated into one.

The voltage generating unit 250 may receive a commercially used voltage (e.g., 110V or 220V of AC voltage) from outside and generate and output various values of DC voltages. By way of example, the voltage generating unit 250 may generate and provide various values of voltage, e.g., DC 15V for the gate one voltage (Vgh) of the gate driver 230_1, DC 24V for the lamp driving unit 260, or DC 23V for the timing controller 220. Furthermore, the voltage generating unit 250 may generate and provide a driving voltage of the image analyzing unit 210.

The lamp driving unit 260 converts the voltage provided from the voltage generating unit 250 and provides the converted voltage to the backlight 270. Further, the lamp driving unit 260 may sequentially drive the RGB LEDs of the backlight 270, or operate in association with the image analyzing unit 210 to drive only the LEDs of the colors corresponding to a specific location. Further, the lamp driving unit 260 may include a feedback circuit to feedback control a driving current of the LED so that uniform light is provided from the RGB LED of the backlight 270.

To explain the associated operation of the image analyzing unit 210 in more detail, the lamp driving unit 260 adaptively controls the backlight 270 according to the result of analysis provided from the image analyzing unit 210. For example, if the image analyzing unit 210 analyzes that the video data includes the grayscale information expressing portion, the lamp driving unit 260 receives information (e.g., coordinate values) about the location of the corresponding grayscale information expressing portion and drives the LEDs of the backlight 270 corresponding to the received coordinate values. Depending on whether the color information expressing portion includes various color information or relatively smaller amount of color, the lamp driving unit 260 may adaptively receive the location information about the color information expressing portion, and drive the LEDs of the backlight 270 adaptively.

In other words, if the image analyzing unit 210 analyzes an incoming image to be a general image as the ones illustrated in (a) and (c) of FIG. 4, the lamp driving unit 260 controls the backlight 270 to drive RGB LEDs sequentially in order of color and in sync with the GRWB unit frame images as illustrated in (a) and (b) of FIG. 5, to obtain highest color purity. For the gray image as the one illustrated in (b) of FIG. 4, referring to (c) of FIG. 5, in an adaptive operation, the backlight 270 is turned off in sync with the GRB unit frame images, and the LEDs of the backlight 270 are all turned on in sync with the W unit frame image.

The adaptive operation will be explained in greater detail below with reference to FIG. 6. (a) of FIG. 6 relates to a GRKB driving method which provides high fidelity color with respect to an image with many color components or high color purity, while (b) of FIG. 6 relates to a GRWB driving method which reduces color breakup (or backlight duty) as much as possible and maintains brightness with respect to an image having less color components or image with less color purity or monochromatic image.

By way of example, the lamp driving unit 260 may control the LEDs of the backlight 270 corresponding to color expressing portions (ADC Off) to be driven in the order of G, P, K, B (images on the left-hand sides to (a) and (b) of FIG. 6) to express various colors on the display panel 240, and control the LEDs of the backlight corresponding to the grayscale expressing portions (ADC On) to be driven in the order of K, K, ½W and K to express the gray image on the display panel 240. The letter ‘K’ refers to a black state formed by turning off the LEDs at the locations corresponding to the grayscale expressing portion for a predetermined time, and ‘½W’ refers to a state formed by turning off the LEDs for the half (½) of a predetermined time and turning on the LEDs for the rest half (½) of the predetermined time.

Referring to FIG. 6, the method for driving the color expressing portion and the grayscale expressing portion according to the second embodiment may provide improved flicker phenomenon than the method for driving the color expressing portion and the grayscale expressing portion according to the first embodiment. According to the second embodiment, ‘¼W’ refers to an operation in which the LEDs are turned off for ¾ of a predetermined time to maintain K state, and then turned on for the rest ¼ of the time to maintain W state. In other words, the driving of the backlight 270 is in association with the image analyzing unit 210 and the lamp driving unit 260.

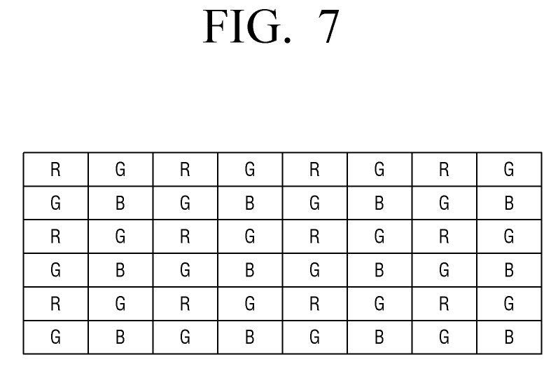

The backlight 270 may include RGB LEDs. In one embodiment, the RGB LEDS have an arrangement as illustrated in FIG. 7. Although FIG. 7 illustrates a direct type according to which RGB LEDs are arranged on the entire lower end of the display panel 240, embodiments may also include the edge type according to which RGB LEDs are arranged on the edge of the display panel 240, or any other arrangement. However, it is preferable that the backlight 270 provides RGB lights in sequence according to the control of the lamp driving unit 260 and adaptively operates. The adaptive operation has been explained with reference to the lamp driving unit 260 so far, but will be elucidated below.

The reference voltage generating unit 280, or gamma-voltage generating unit, may receive a DC 10V voltage from the voltage generating unit 250, in which case the reference voltage generating unit 280 may segment the received voltage into a plurality of voltages through dividing resistors, and provide the voltage to the source driver 230_2. Accordingly, the source driver 230_2 may further segment the received plurality of voltages and express 2556 grayscales of the RGB data, for example.

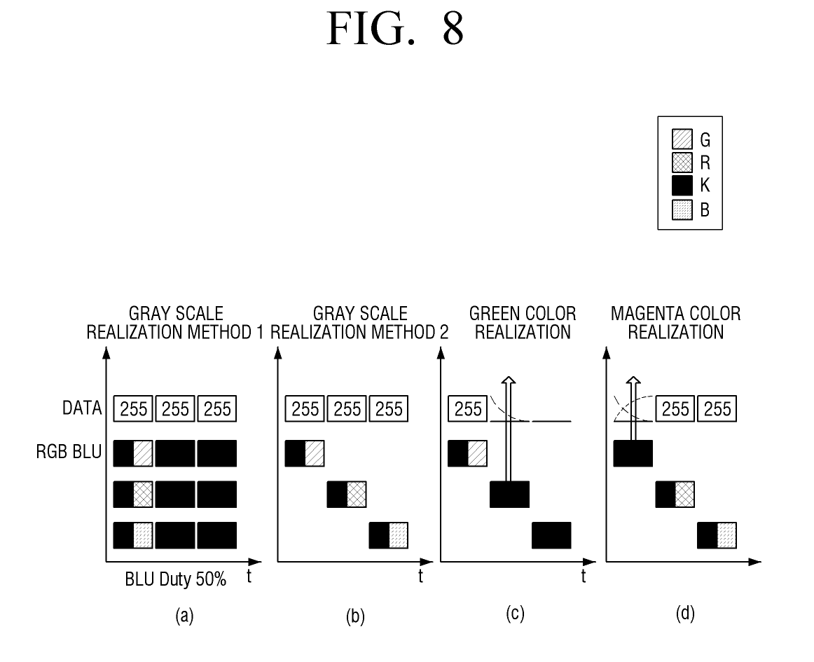

FIG. 8 illustrates an example of a method for adaptive blu-duty control (ADC) driving in RGB mode.

Referring to FIG. 8 in combination with FIG. 2, a device for displaying images according to an embodiment may be driven differently depending on whether the three color sequence driving of the RGB is full white/gray image, color image, and low-color image. The ‘gray’ refers to RGB pixels that have the same values. For example, it is white if there are 255 gray values of RGB pixels, while it is grayscale 128 if there are 128 grayscales of RGB pixel values.

First, with respect to a full white/gray image, the backlight 270 may drive RGB in the manner as illustrated in (a) and (b) of FIG. 8. In other words, referring to (a) of FIG. 8, the time point (i.e., timing) at which the unit frame image of a specific color is realized, ½ duty region becomes black, while all the RGB LEDs are turned on in the rest ½ duty region.

If a color image is a monochromatic color image that includes only one color or that equally includes two color components, referring to (c) of FIG. 8, the BLU duty of the corresponding color is maintained, while the other BLU duties are gradually decreased so that the BLU of the final color is exclusively driven. In this manner, color breakup can be reduced.

For a weak hue image, the image is applicable to an example where the screen overall has less color components and more gray components. Accordingly, the color component ratio with respect to the color component contained in the entire screen may be calculated based on the ratio of an image (or number of pixels) containing color component with respect to the entire image (or number of pixels). Depending on the calculated ratio, color breakup can be reduced by reducing the RGB BLU duties in a predetermined manner as shown in (d) of FIG. 8.

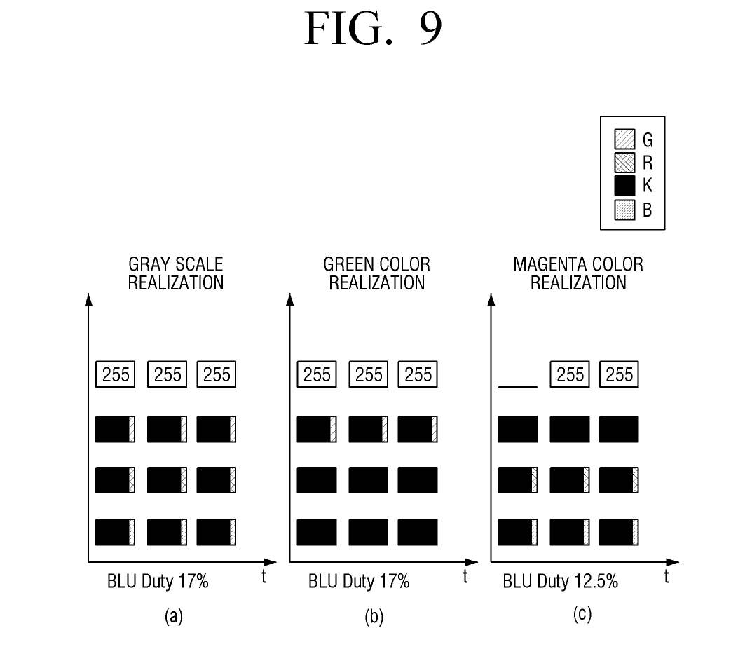

FIG. 9 is a view illustrating another example of ADC driving in RGB mode.

Referring to FIG. 9, in combination with FIG. 2, the device for displaying images according to an embodiment improves not only color mix-up and subsequent color breakup, but also flicker phenomenon by equally distributing the duties in the entire color sequence and turning off the backlight 270. In one embodiment, FIG. 9 illustrates an example where the BLU duties are divided equally into 12.5% or 17%.

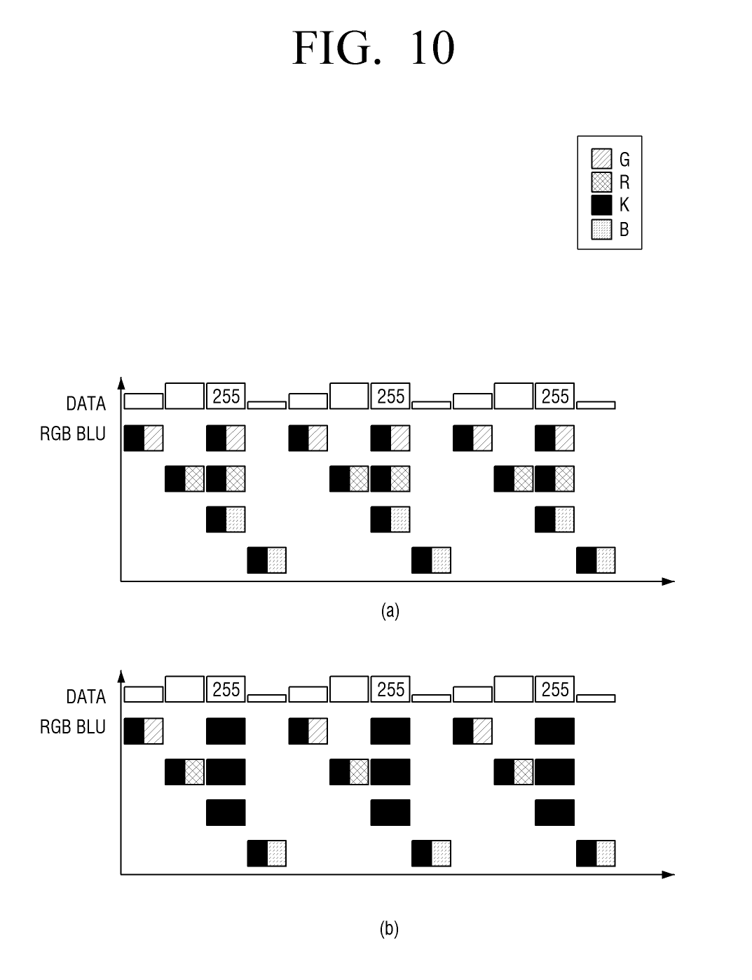

FIG. 10 is a view illustrating an RGB sequence to reduce color breakup and increase color purity in WRGB driving.

Referring to (a) of FIG. 10, GRWB sequence is illustrated as an example of driving for a general image. Since the ½ duty of the entire unit frames of GRWB becomes white state, brightness and color breakup is improved.

Further, referring to (b) of FIG. 10, GRKB sequence is illustrated as an example of driving for a general image. Likewise in the example of (a) of FIG. 10, since the ½ duty of the entire GRKB unit frames become a black state, brightness and color breakup is improved.

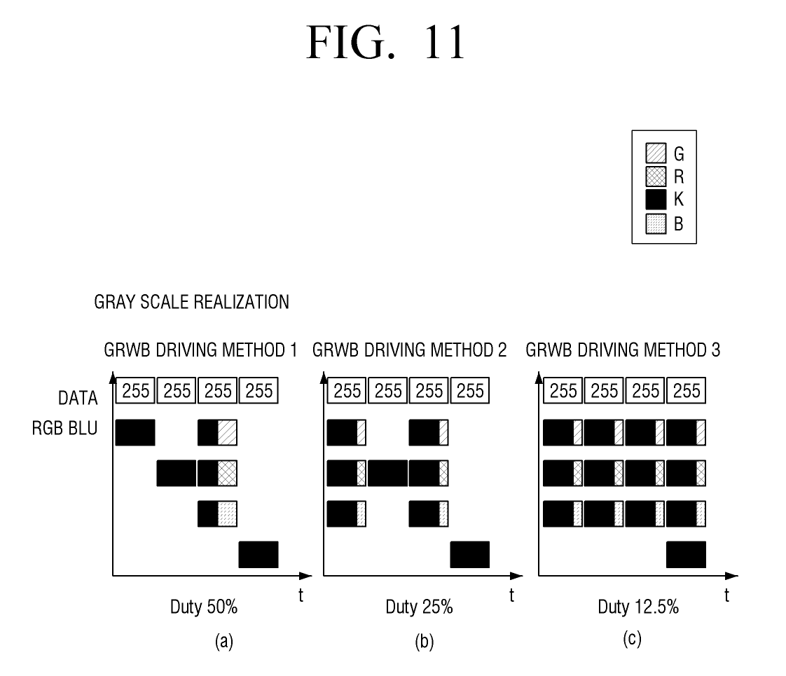

FIG. 11 is a view illustrating an example of ADC driving in WRGB mode, and

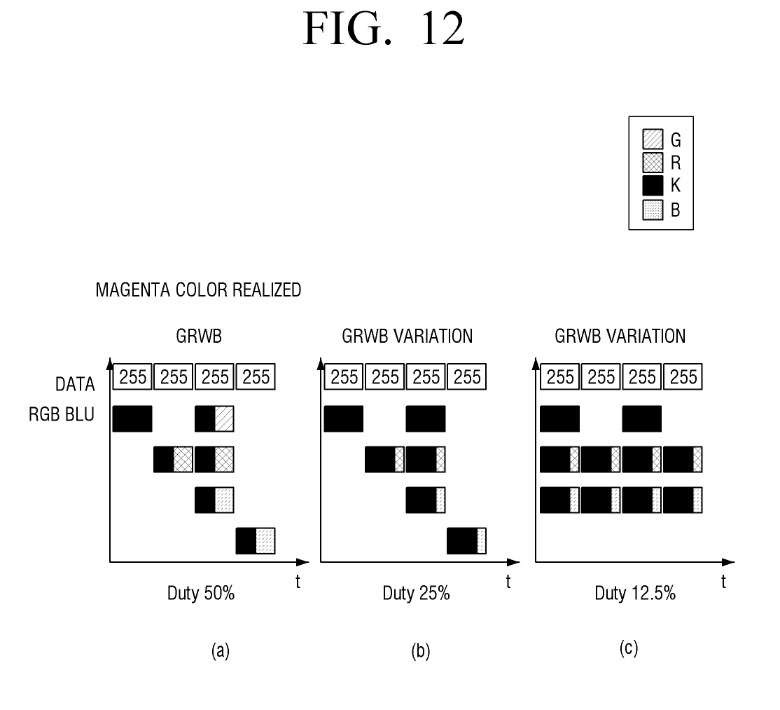

FIG. 12 is a view illustrating another example of ADC driving in WRGB mode.

Referring to FIGS. 11 and 12 in combination with FIG. 2, the device for displaying images according to an embodiment may drive differently, when the four WRGB sequence driving is a full white/gray image, depending on whether the image is color image or weak hue color image.

First, the WRGB driving of the backlight 270 may be implemented as illustrated in FIG. 11 with respect to full white/gray image. In other words, the RGB duties are gradually decreased at a time point when the unit frame image of a specific color is realized, and the white duty is gradually increased so that the RGB are driven with predetermined duty only at the final white timing. For example, referring to (a) to (c) of FIG. 11, the driving may cause white state in the ½ (50%) of the entire duty region, or in the duty region corresponding to final 12.5% and 25%. As a result, color breakup can be reduced and flicker can also be reduced.

Further, if a color image is a monochromatic image that includes only one color or that equally includes two color components, the BLU duty of the corresponding color is maintained, while the other BLU duties are gradually decreased so that the BLU of the final color is exclusively driven. In this manner, color breakup can be reduced.

For a weak hue image, in the RGB mode, the image has less color components and more gray components. Accordingly, the color component ratio with respect to the color component contained in the entire screen may be calculated based on the ratio of an image (or number of pixels) containing color component with respect to the entire image (or number of pixels). Depending on the calculated ratio, color breakup can be reduced by reducing the RGB BLU duties in a predetermined manner as shown in FIG. 12.

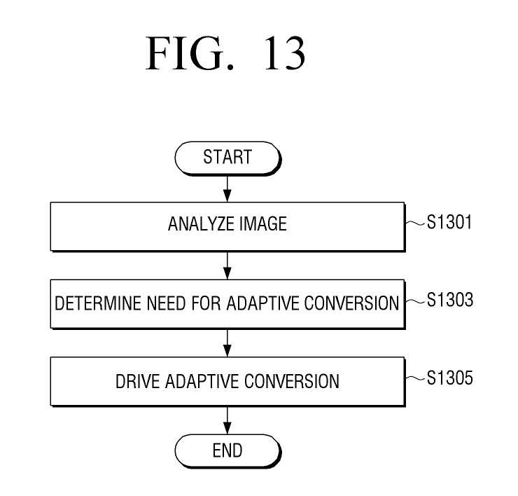

FIG. 13 is a view illustrating a method for displaying images according to an embodiment.

Referring to FIG. 13 in combination with FIG. 2, at S1301, the device for displaying images according to an embodiment analyzes an incoming image. During this process, the device may distinguish the color information expressing portion which expresses relatively many colors, and a grayscale information expressing portion which expresses texts, etc. Furthermore, the device may also determine in detail if the color expressing portion or the grayscale expressing portion requires brightness compensation, has severe color breakup, or needs color rendering ability as an important element. Further, if the CFL is implemented as the device for displaying images, according to an embodiment, at S1301, the device may generate R unit frame, G unit frame and B unit frame respectively from the RGB mixed unit frame image, or additionally generate black (K) frame or white (W) frame.

After that, at S1303, the device for displaying images may determine if adaptive variation is necessary. For example, if the device determines as a result of analyzing that the unit frame does not include the grayscale information expressing portion, the device may determine to drive in RGB or WRGB sequence. On the contrary, if it is determined that the unit frame includes the grayscale information expressing portion, the device may drive in RGB or WRGB sequence, but additionally determine a specific duty of the entire duty realized on a specific unit frame that is to be turned into white (W) or black (K) state.

At S1305, upon determining the adaptive variation to be necessary, the device for displaying images may perform adaptive variation driving according to the result of determination. In other words, if the device determines an incoming image to be a general image and thus determines to drive in RGB or WRGB sequence, the device drives the RGB LEDs of the backlight 270 sequentially in the order of colors. On the contrary, if the device determines that the adaptive driving is necessary, the device drives the RGB LEDs corresponding to the grayscale information expressing portion are driven so that a specific duty of the timing realized on a specific frame is turned into black (K) or white (W) state.

In view of the above, the device for displaying images according to an embodiment determines whether to turn into black state or white state in the process of determining the need for adaptive variation S1303 so that the adaptive variation driving is implemented at S1305 according to the result of determination.

Since the LED backlight is adaptively driven according to the result of analyzing an image, a CFL can have improvement of color breakup due to color mix-up and flicker.

The foregoing exemplary embodiments and advantages are merely exemplary and are not to be construed as limiting embodiments. The present teaching can be readily applied to other types of apparatuses. Also, the description of the exemplary embodiments is intended to be illustrative, and not to limit the scope of the claims. Many alternatives, modifications, and variations will be apparent to those skilled in the art.

What is claimed is:

1. A device for displaying images, comprising:
an image analyzing unit which analyzes an incoming unit frame image and provides a result of the analysis related to an area on which a color characteristic is expressed, which has a different characteristic from a color characteristic of a peripheral area; and
a backlight which comprises light emitting diodes (LED), each LED operates differently according to presence and absence of the area on which the color characteristic is expressed, which has a different characteristic from the color characteristic of a peripheral area, by using the result of analysis.

2. The device of claim 1, wherein the backlight drives the LED of the area in a sequential manner, if the incoming unit frame image does not include the area on which the color characteristic is expressed, which has a different characteristic from the color characteristic of the peripheral area, and
drives the LED of the area on which the color characteristic is expressed, which has a different characteristic from the color characteristic of the peripheral area, in a manner other than the sequential manner, if the unit frame image includes the area on which the color characteristic is expressed, which has a different characteristic from the color characteristic of the peripheral area.

3. The device of claim 1, wherein the image analyzing unit provides, as the result of the analysis, location information of the area on which the color characteristic is expressed, which has a different characteristic from the color characteristic of the peripheral area.

4. The device of claim 1, wherein the peripheral area has more color components or higher color purity than the area on which the color characteristic is expressed, which has a different characteristic from the color characteristic of the peripheral area, and
the area on which the color characteristic is expressed, which has a different characteristic from the color characteristic of the peripheral area, expresses a gray component, a monochromatic component, and a complex color component of two colors.

5. The device of claim 4, wherein the image analyzing unit analyzes R, G, B pixel values of the incoming unit image frame and determines the image to be the gray component, if the R, G, B pixel values have a same grayscale value.

6. The device of claim 1, wherein the image analyzing unit separates a unit frame image of mixed R, G, B to generate a R unit frame, a G unit frame, and a B unit frame and outputs the generated R unit frame, the generated G unit frame, and the generated B unit frame.

7. The device of claim 6, wherein the image analyzing unit additionally generates and outputs a black (K) unit frame or a white (W) unit frame.

8. The device of claim 1, further comprising a lamp driving unit, and the lamp driving unit adaptively drives the backlight according to the result of the analysis.

9. The device of claim 8, wherein the lamp driving unit is synchronized with part of the unit frames of the R unit frame, the G unit frame, the B unit frame, the black (K) unit frame, or the white (W) unit frame to drive the LED backlight in a RGB mode of three color driving, a WRGB mode of four color driving, or a KRGB mode of four color driving.

10. The device of claim 8, wherein the lamp driving unit controls the LEDs of the backlight corresponding to the area on which the color characteristic is expressed, which has a different characteristic from the color characteristic of the peripheral area, are driven, and controls the LEDs so that the LEDs turn into a different state in a duty region where the incoming unit frame is displayed.

11. The device of claim 10, wherein, the lamp driving unit controls the LEDs so that if ½ region of the duty is in a black (K) state, the rest ½ region is in a white (W) state, or if the ½ region of the duty is in the white (W) state, the rest ½ region is in the black (K) state.

12. The device of claim 11, wherein the white (W) state is generated by turning on the R, G, B LEDs corresponding to the area on which the color characteristic is expressed, which has a different characteristic from the color characteristic of the peripheral area.

13. A device for displaying images, comprising:
an image analyzing unit which analyzes an incoming unit frame image and determines visibility of the incoming unit frame image; and
a lamp driving unit which controls a light emitting diode (LED) backlight to turn on or off according to a result of visibility determination.

14. The device of claim 13, wherein the image analyzing unit analyzes the incoming unit frame image to determine if the image needs brightness compensation, has severe color breakup, or needs color rendering ability, to determine the visibility of the incoming unit frame image.

15. The device of claim 13, wherein the image analyzing unit sets at least one mode of a RGB mode, a GRWB mode, and a GRKB mode according to the result of visibility determination, and wherein W refers to white and K refers to black.

16. A method for displaying images, comprising:
analyzing an incoming image;
determining at least one of:
presence of an area on which a color characteristic is expressed, which has a different characteristic from a color characteristic of a peripheral area, and a
visibility state of the image; and
driving a light emitting diode (LED) backlight differently according to a result of the determination.

17. The method of claim 16, wherein the analyzing the incoming image comprises comparing pixel values of a unit frame image having R, G, B mixed.

18. The method of claim 16, wherein the determining of the visibility state comprises determining if the image needs brightness compensation, has severe color breakup, or needs color rendering ability, to determine the visibility state of the image.

19. The method of claim 16, wherein the peripheral area has more color components or higher color purity than the area on which the color characteristic is expressed, which has a different characteristic from the color characteristic of the peripheral area, and
the area on which the color characteristic is expressed, which has a different characteristic from the color characteristic of the peripheral area, expresses a gray component, a monochromatic component, and a complex color component of two colors.

20. The method of claim 16, wherein the LED backlight operates in a RGB mode of three color driving, a WRGB mode of four color driving, or a KRGB mode of four color driving.

21. The method of claim 16, wherein the LED backlight drives the peripheral area differently from the area on which the color characteristic is expressed.

22. The method of claim 21, wherein the LED backlight differently operates a duty region of the unit frame image, if the unit frame image is displayed by including the area on which the color characteristic is expressed, which has a different characteristic from the color characteristic of the peripheral area.

23. The method of claim 22, wherein the LED backlight drives a partial region of a duty region in a black (K) state or a white (W) state.
